(19) United States
(12) Patent Application Publication
(10) Pub. No.: US 2007/0181595 A1
(43) Pub. Date: Aug. 9, 2007

(54) Automatic dose size selection for multi-component fluid proportioners

(76) Inventors: Theodore J. Stone, St. Louis Park, MN (US); Wade D. Palashewski, Andover, MN (US); Vu K. Nguyen, Brooklyn Park, MN (US); Dennis J. Vankeulen, Rogers, MN (US)

Correspondence Address: GRACO MINNESOTA INC, PO BOX 1441, MINNEAPOLIS, MN, 55440, US

(21) Appl. No.: 10/599,090

(22) PCT Filed: Apr. 14, 2005
(86) PCT No.: PCT/US05/12690

§ 371 Date: Sep. 19, 2006

(30) Foreign Application Priority Data
Apr. 15, 2004 (US) 60562435

(51) Int. Cl. B67B 7/00

(52) U.S. Cl. 222/1

(57) ABSTRACT

The invention is for use with a plural component sequential metering system. In the method of the invention, after a selected number of doses have been dispensed, the system stops and calculates how many of those doses have fallen within a predetermined tolerance of the desired ratio between the two materials. If too many doses fall outside the tolerance, the dose size is decreased. This process is repeated until the appropriate number of doses fall within the desired tolerance.

### TECHNICAL FIELD

This application claims the benefit of U.S. Application Ser. No. 60/562,435, filed Apr. 15, 2004.

### BACKGROUND ART

Devices for dispensing plural component materials have become increasingly popular in recent years, as such materials have assumed more widespread usage in industry. As used herein, a catalyst (or first fluid) is mixed with a resin (or second fluid). While the terms catalyst and resin are used for purposes of convenience in reference, it is understood that other plural component systems may be utilized which might not normally utilize such terminology.

Also known are systems such as those sold under the PRECISION-MIX trademark by the assignee of the instant invention and generally described in European patent number 116879 and U.S. Pat. No. 5,368,059, the contents of which are both hereby incorporated by reference. In such systems, the two fluids to be dispensed both have a flow meter and a valve associated with them. A fixed amount of the first fluid is dispensed into a mixer and then a fixed amount of the second fluid is dispensed into the mixer, whereupon the process is repeated. Traditionally, electronic proportioners have required that the dose size either be fixed or entered by the user. Selecting the appropriate dose size has been dependent on factors such as flow rate, viscosity, and mix ratio. This invention allows for better overall mix performance and improved usability since there is no input from the user required.

### DISCLOSURE OF THE INVENTION

In the method of the instant invention, after a selected number of doses have been dispensed, the system stops and calculates how many of those doses have fallen within a predetermined tolerance of the desired ratio between the two materials. If too many doses fall outside the tolerance, the dose size is decreased. This process is repeated until the appropriate number of doses fall within the desired tolerance.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a flow chart showing the dose selection method of the instant invention.

### BEST MODE FOR CARRYING OUT THE INVENTION

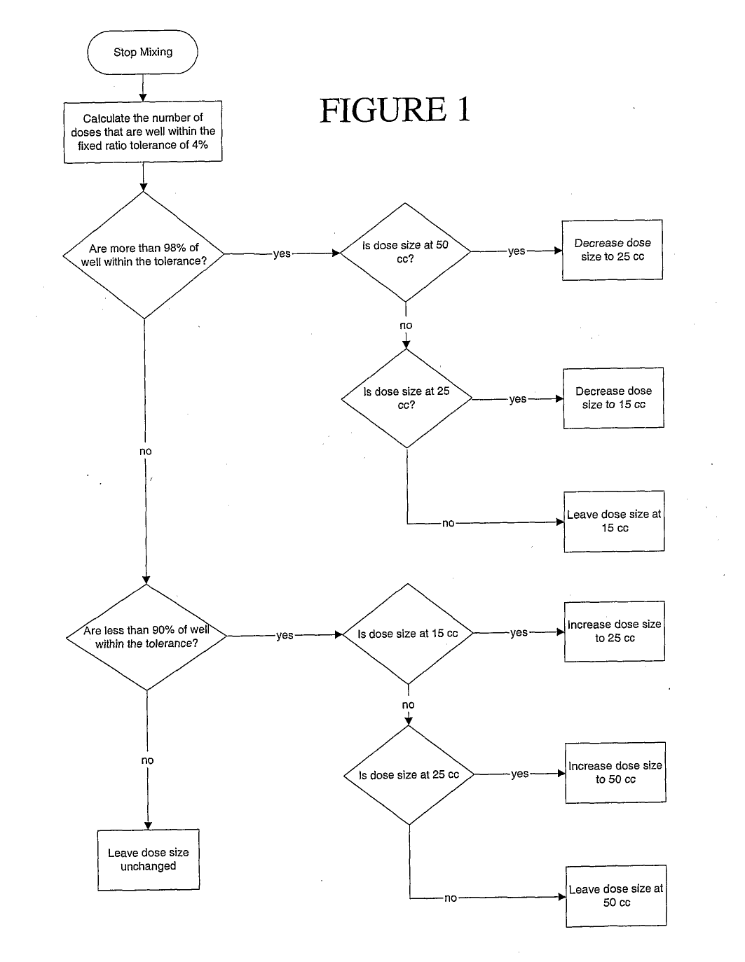

FIG. 1 shows a flow chart detailing the instant invention. In the method of the instant invention, a selected number of doses are dispensed. The system then stops and calculates how many of those doses have fallen within a predetermined tolerance (98% in the preferred embodiment) of the desired ratio (e.g. 2:1) between the two materials. If too many doses fall outside the tolerance, the dose size is decreased from the initial setting (50 cc in the preferred embodiment). This process is repeated until the appropriate number of doses fall within the desired tolerance.

Systems that use sequential proportioning have two parameters that can be difficult for a user to choose. These are the ratio tolerance and the dose size. The optimal settings for these parameters are usually selected based on the flow rate, mix ratio, and viscosity of the fluid. Selection of these parameters usually requires an experienced operator and/or a trial and error process to determine the appropriate values.

The automatic dose size feature provides a method where the software selects the correct dose size based on historical data from the device. The software algorithm learns the characteristics of the physical system by monitoring how well the mix ratio can be maintained. This way, the next time the equipment is put into the mix mode, an optimal dose size is selected.

The other advantage of this feature is that the smallest feasible dose size is always selected. Laboratory testing has proved that there is a relationship between how small a dose size is and how well two components are integrated and mixed. If the dose size becomes too small, a consistent ratio cannot be maintained due to the unpredictability of the valve timing.

From a process control perspective, it is not desirable for the dose size to be constantly changing. For this reason, the calculation for changing the dose size is only made when the system is changed from the mix mode to the standby mode. This way, the next time system is put back into the mix mode; the new optimal dose size is used.

It is contemplated that various changes and modifications may be made to the method without departing from the spirit and scope of the invention as defined by the following claims.

1. A method of setting dose size for a plural component sequential metering system for dispensing materials having at least first and second components and comprising the steps of:
dispensing a plurality of doses of plural component material;
measuring the ratio between said components in said plurality of doses;
determining the number of said plurality which fall within a predetermined tolerance of the desired ratio; and
decreasing said dose size when the number of doses falling outside said predetermined tolerance exceeds a predetermined level

2. The method of claim wherein said metering system has a standby mode and said dose size is changed only when in said standby mode.
